(19) United States
(12) Patent Application Publication
(10) Pub. No.: US 2025/0148486 A1
(43) Pub. Date: May 8, 2025

(54) TIME DISCOUNT RATE ESTIMATION APPARATUS, MACHINE LEARNING METHOD, TIME DISCOUNT RATE ANALYSIS METHOD, AND PROGRAM

(71) Applicant: NIPPON TELEGRAPH AND TELEPHONE CORPORATION, Tokyo (JP)

(72) Inventors: Shuhei YAMAMOTO, Tokyo (JP); Takeshi KURASHIMA, Tokyo (JP); Shuichi NISHIOKA, Tokyo (JP); Tomu TOMINAGA, Tokyo (JP)

(21) Appl. No.: 18/835,505

(22) PCT Filed: Feb. 24, 2022
(86) PCT No.: PCT/JP2022/007549

§ 371 Date: Aug. 2, 2024

(51) Int. Cl. G06Q 30/0201; G06F 1/16

(52) U.S. Cl. CPC G06Q 30/0201; G06F 1/163

(57) ABSTRACT

An object of the present disclosure is to accurately estimate a time discount rate of a user without depending on a measurement method using questionnaires.

Therefore, the present disclosure provides a time discount rate estimation apparatus that estimates a time discount rate in a learning phase, the time discount rate estimation apparatus including: a model learning unit configured to calculate an error between a value obtained by standardizing values of a plurality of behavior features of a user and then multiplying each of the standardized values by a model parameter indicating each coefficient serving as a weight and a time discount rate serving as ground-truth data based on an answer by the user and to perform machine learning on the model parameter so as to reduce the error.

### TECHNICAL FIELD

The present invention relates to a technique of analyzing a time discount rate, and particularly to a technique of accurately and automatically estimating a time discount rate of a user from a daily behavioral record of the user.

### BACKGROUND ART

Indicating human personality with quantitative numerical values is one of important elements for human understanding addressed in fields such as psychology and economics. Economics traditionally treat human personality as three types of elements: “time discount rate”, “risk aversion rate”, and “reciprocity”. Among the elements, the time discount rate is an index obtained by focusing on “how much a person hates to wait”. In particular, the time discount rate is obtained by focusing on a human nature that “a value of a certain reward is discounted based on time depending on how low a person subjectively perceives a future value of the reward (delayed reward) compared with its current value (immediate reward)” and is treated as a parameter of an attenuation function (e.g. exponential function or hyperbolic function) of the discount. The time discount rate has been statistically investigated mainly in behavioral economics in conjunction with human attributes and has been shown to be an important element affecting a wide range of life domains. For example, a high time discount rate (a person who tends to hate waiting) is correlated with high rates of debt, obesity, and smoking (Non Patent Literature 1). When the time discount rate of each individual is clarified, a person himself/herself or other people can quantitatively understand how much the person can endure “waiting” in his/her life. Based on this understanding, it is also possible to improve his/her life by supporting his/her decision making.

Methods of measuring the time discount rate by using questionnaires has been developed so far. Two measurement methods have been mainly proposed and used in various statistical surveys so far (Non Patent Literature 2). One of the methods is a measurement method using the “choice questionnaire”. For example, a plurality of questions regarding “Would you rather receive X yen today (option A) or Y yen seven days later (option B)?” is prepared such that Y yen is higher than X yen in each question, and respondents choose an option. At this time, because a price in the option B is higher, a question designer has an “annual interest” as in a bank deposit. Focusing on a question in which selection is changed from the option A (receive today) to the option B (receive seven days later) among answer results, a discount rate of a respondent is assumed to be present between an annual interest of the question in which selection is changed and an annual interest of a question before the question, and thus an average value of the two annual interests is adopted as the time discount rate. The other method is a measurement method using the “self-completed questionnaire”. This method includes, for example, a single question “If you receive X yen today or receive Y yen seven days later, please write a price Y with a value equivalent to X yen.”, and an annual interest calculated from a difference between the written price Y yen and X yen is adopted as it is as the time discount rate.

### CITATION LIST

### Non Patent Literature

Non Patent Literature 1: Mischel, Walter et al. “‘Willpower’ over the life span: decomposing self-regulation.”Social cognitive and affective neuroscience, Vol. 6, No. 2 (2011): 252-6.
Non Patent Literature 2: Hardisty, David J. et al. “How to measure time preferences: An experimental comparison of three methods.” Judgment and Decision Making Vol. 8 (2013): 236-249.

### SUMMARY OF INVENTION

### Technical Problem

In the measurement method using the self-completed questionnaire, the burden on respondents is small because the respondents only need to answer a single question. Meanwhile, the respondents can write any price, and thus answer results of a respondent group tend to be dispersed. Therefore, it is difficult to measure an accurate time discount rate and also to compare the time discount rate with attribute information of the respondent group.

In the measurement method using the choice questionnaire, time discount rates of respondents are allocated based on annual interests determined by the question designer in advance. Thus, answers do not tend to be dispersed. Meanwhile, it is necessary to answer a plurality of questions. Further, the order of questions is randomly changed for each of the annual interests in order to avoid the respondents from irresponsibly answering questions (e.g. continuing to select the option B without consideration). In a case where there is a plurality of portions where the option A and the option B are switched, the answer is considered invalid, which is the case for many of the answers of the respondents. Therefore, the time discount rate cannot be appropriately measured in many cases. Further, because it is necessary to answer a plurality of questions, the burden on the respondents is heavy, and measurement is performed at medium to long time intervals. Therefore, it is difficult to detect a change thereof.

The present invention has been made in view of the above points, and an object thereof is to accurately estimate a time discount rate of a user without depending on a measurement method using questionnaires.

### Solution to Problem

In order to achieve the above object, an invention according to claim 1 is a time discount rate estimation apparatus that estimates a time discount rate in a learning phase, the time discount rate estimation apparatus including: a model learning unit that calculates an error between a value obtained by standardizing values of a plurality of behavior features of a user and then multiplying each of the standardized values by a model parameter indicating each coefficient serving as a weight and a time discount rate serving as ground-truth data based on an answer by the user and performs machine learning on the model parameter so as to reduce the error.

### Advantageous Effects of Invention

As described above, the present invention can accurately estimate a time discount rate of a user without depending on a measurement method using questionnaires.

### BRIEF DESCRIPTION OF DRAWINGS

FIG. 1 is a functional configuration diagram of a time discount rate estimation apparatus in a learning phase according to an embodiment.

FIG. 2 is a functional configuration diagram of a time discount rate estimation apparatus in an estimation phase according to an embodiment.

FIG. 3 is a hardware configuration diagram of a time discount rate analysis apparatus according to an embodiment.

FIG. 4 shows tables forming a behavior data DB, FIG. 4(a) is a conceptual diagram of a behavior amount management table, and FIG. 4(b) is a conceptual diagram of a behavior date and time management table.

FIG. 5 is a conceptual diagram of a table forming a time discount rate data DB.

FIG. 6 is a conceptual diagram of a table forming an evaluation value storage DB.

FIG. 7 is a flowchart showing an overview of time discount rate estimation processing in a learning phase.

FIG. 8 is a flowchart showing an overview of time discount rate estimation processing in an estimation phase.

FIG. 9 is a flowchart showing processing of a behavior data preprocessing unit.

FIGS. 10(a) and 10(b) are conceptual diagrams showing an output example of a behavior data preprocessing unit.

FIG. 11 is a flowchart showing processing of a behavior statistic amount calculation unit.

FIG. 12 is a conceptual diagram showing an output example of a behavior statistic amount calculation unit.

FIG. 13 is a flowchart showing processing of a behavior date and time preprocessing unit.

FIG. 14 is a conceptual diagram showing an output example of a behavior date and time preprocessing unit.

FIG. 15 is a flowchart showing processing of a behavior transition calculation unit.

FIG. 16 is a conceptual diagram showing an output example of a behavior transition calculation unit.

FIG. 17 is a flowchart showing processing of a behavior difference amount calculation unit.

FIG. 18 is a conceptual diagram showing an output example of a behavior difference amount calculation unit.

FIG. 19 is a flowchart showing processing of a behavior feature correlation calculation unit.

FIG. 20 is a conceptual diagram showing an output example of a behavior feature correlation calculation unit.

FIG. 21 is a flowchart showing processing of a feature selection unit.

FIG. 22 is a flowchart showing processing of a model learning/selection unit.

FIG. 23 is a flowchart showing processing of a time discount rate estimation unit.

### DESCRIPTION OF EMBODIMENTS

### Overview of Embodiment

In recent years, individuals have come to have wearable devices, and it has become easy to observe and digitalize daily individual behavior. Behavior is observed as a result of decision making. A correlation between a time discount rate and life behavior results such as obesity and smoking has been confirmed. Therefore, it is possible to estimate the time discount rate behind decision making by analyzing more detailed daily behavior (e.g. sleep, diet, and exercise) pattern. By estimating the time discount rate from this automatically measured behavior data, it is possible to reduce the burden of individuals answering questionnaires and to clarify the time discount rate with finer time granularity (e.g. one week or one month). This makes it possible to support self-understanding and decision making according to the lapse of time.

A time discount rate estimation apparatus 1 of the present embodiment accurately estimates the time discount rate of an individual from behavior data automatically observed by a wearable device or the like without depending on a measurement method using questionnaires.

### [Hardware Configuration of Time Discount Rate Analysis Apparatus]

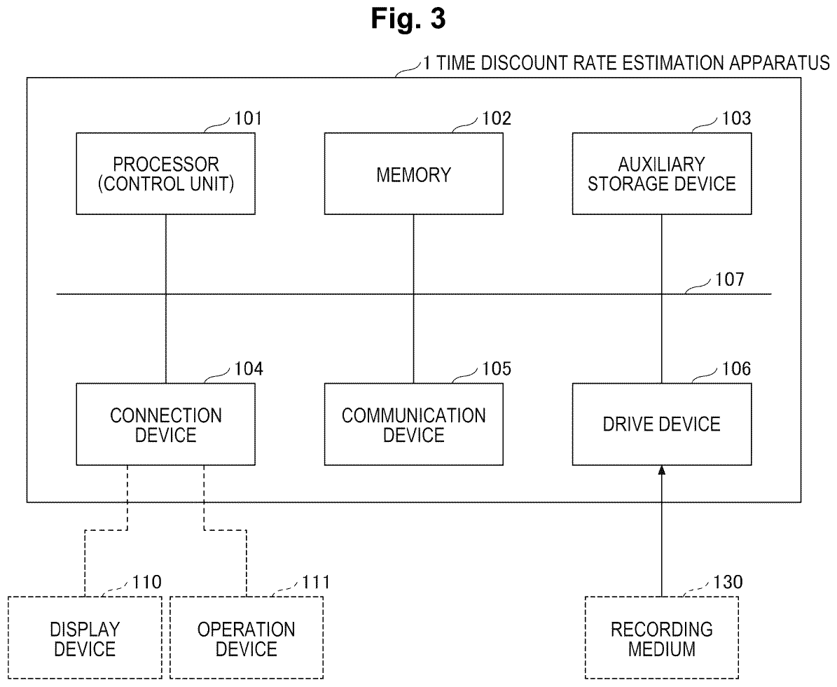

Next, a hardware configuration of the time discount rate analysis apparatus 1 will be described with reference to FIG. 3. FIG. 3 is a hardware configuration diagram of the time discount rate analysis apparatus according to the embodiment.

As shown in FIG. 3, the time discount rate analysis apparatus 1 includes a processor 101, a memory 102, an auxiliary storage device 103, a connection device 104, a communication device 105, and a drive device 106. Pieces of hardware included in the time discount rate analysis apparatus 1 are connected to each other via a bus 107.

The processor 101 serves as a control unit that controls the entire time discount rate analysis apparatus 1 and includes various arithmetic devices such as a central processing unit (CPU). The processor 101 reads various programs on the memory 102 and executes the programs. The processor 101 may include a general-purpose computing on graphics processing unit (GPGPU).

The memory 102 includes a main storage device such as a read only memory (ROM) or a random access memory (RAM). The processor 101 and the memory 102 form what is known as a computer, and, when the processor 101 executes the various programs read on the memory 102, the computer implements various functions.

The auxiliary storage device 103 stores the various programs and various types of information used when the various programs are executed by the processor 101.

The connection device 104 connects an external device (e.g. display device 110 or operation device 111) and the time discount rate analysis apparatus 1.

The communication device 105 transmits and receives various types of information to and from other devices.

The drive device 106 is a device in which a (non-transitory) recording medium 130 is set. The recording medium 130 here includes a medium that optically, electrically, or magnetically records information, such as a compact disc read-only memory (CD-ROM), a flexible disk, or a magneto-optical disk. The recording medium 130 may also include a semiconductor memory or the like that electrically records information, such as a read only memory (ROM) or a flash memory.

Note that the various programs to be installed in the auxiliary storage device 103 are installed, for example, by setting the distributed recording medium 130 in the drive device 106 and reading the various programs recorded in the recording medium 130 by using the drive device 106. Alternatively, the various programs to be installed in the auxiliary storage device 103 may be installed by being downloaded from a network via the communication device 105.

### [Functional Configuration of Time Discount Rate Analysis Apparatus]

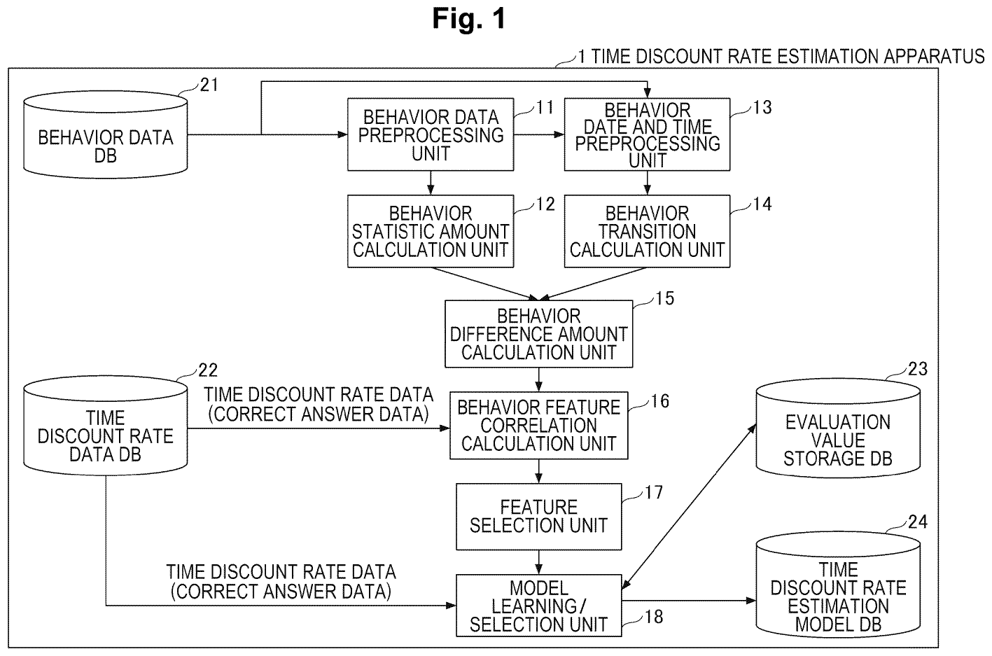

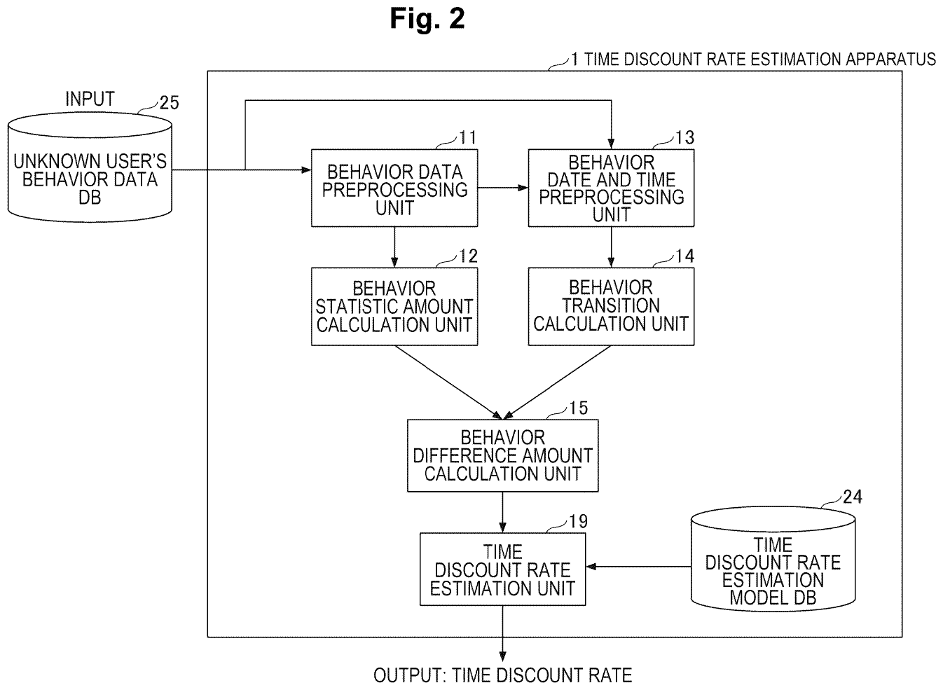

Hereinafter, one embodiment of the present invention will be described. FIG. 1 is a functional configuration diagram of the time discount rate estimation apparatus in a learning phase according to the embodiment. FIG. 2 is a functional configuration diagram of the time discount rate estimation apparatus in an estimation phase according to the embodiment.

As shown in FIG. 1, the time discount rate estimation apparatus 1 in the learning phase includes a behavior data preprocessing unit 11, a behavior statistic amount calculation unit 12, a behavior date and time preprocessing unit 13, a behavior transition calculation unit 14, a behavior difference amount calculation unit 15, a behavior feature correlation calculation unit 16, a feature selection unit 17, and a model learning/selection unit 18. Those units are functions implemented by commands from the processor 101 of FIG. 3 on the basis of a program.

The time discount rate estimation apparatus 1 in the learning phase further includes a behavior data database (DB) 21, a time discount rate data DB 22, an evaluation value storage DB 23, and a time discount rate estimation model DB 24. Each of the DBs is built in the memory 102 or an auxiliary storage device 203 described later. The time discount rate estimation apparatus 1 in the learning phase outputs a learned time discount rate estimation model by using information in each DB. Hereinafter, the time discount rate model may be simply referred to as a “model”.

Meanwhile, as shown in FIG. 2, the time discount rate estimation apparatus 1 in the estimation phase includes the behavior data preprocessing unit 11, the behavior statistic amount calculation unit 12, the behavior date and time preprocessing unit 13, the behavior transition calculation unit 14, the behavior difference amount calculation unit 15, and a time discount rate estimation unit 19. Those units are functions implemented by commands from the processor 101 of FIG. 3 described later on the basis of a program.

The time discount rate estimation apparatus 1 in the estimation phase further includes the time discount rate estimation model DB 24 and an unknown user's behavior data DB 25. Each of the DBs is built in the memory 102 or the auxiliary storage device 203. The time discount rate estimation apparatus 1 in the learning phase outputs a learned time discount rate estimation model by using information in each DB.

### <Behavior Data DB>

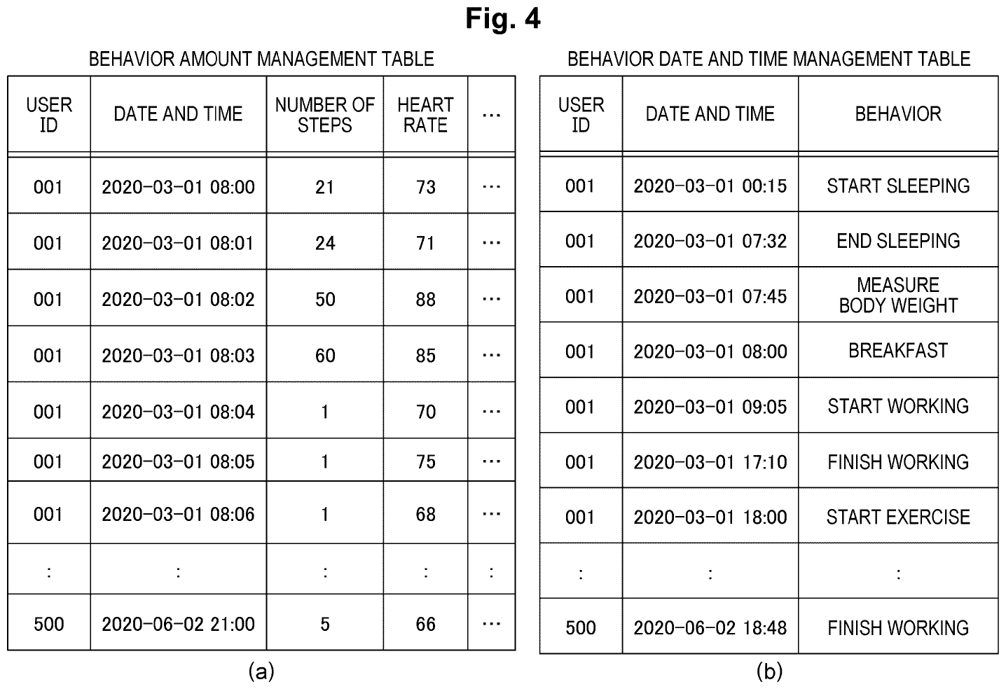

FIG. 4 shows tables forming the behavior data DB, FIG. 4(a) is a conceptual diagram of a behavior amount management table, and FIG. 4(b) is a conceptual diagram of a behavior date and time management table. The behavior data BD 21 stores a behavior automatically recorded by a wearable device or recorded by a user himself/herself together with a user ID, a date and time, and an amount of the behavior or with the user ID, the date and time, and a character string indicating the type (content) of the behavior. The type of behavior may be stored in the behavior data DB 21 within a range in which a system administrator can collect the type of behavior. The user ID is an example of user identification information, and a symbol or numerical value that can uniquely specify the user may be allocated. Specifically, the table is configured as follows.

(Behavior Amount Management Table) As shown in FIG. 4(a), the behavior amount management table manages behavior amount data in which the user ID is associated with date and time of a behavior, the number of steps, a heart rate, and the like of the user specified by the user ID.

### (Behavior Date and Time Management Table)

As shown in FIG. 4(b), the behavior date and time management table manages behavior date and time data in which the user ID is associated with date and time of a behavior of the user specified by the user ID and the type (content) of the behavior.

### <Time Discount Rate Data DB>

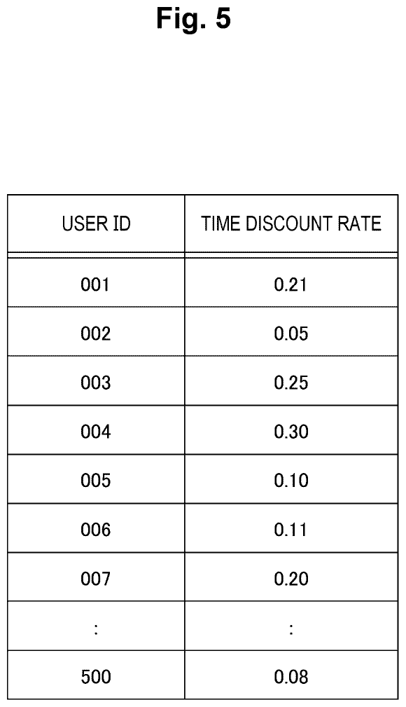

FIG. 5 is a conceptual diagram of a table forming the time discount rate data DB. In the time discount rate data DB 22, the time discount rate is managed for each user ID.

### <Evaluation Value Storage DB>

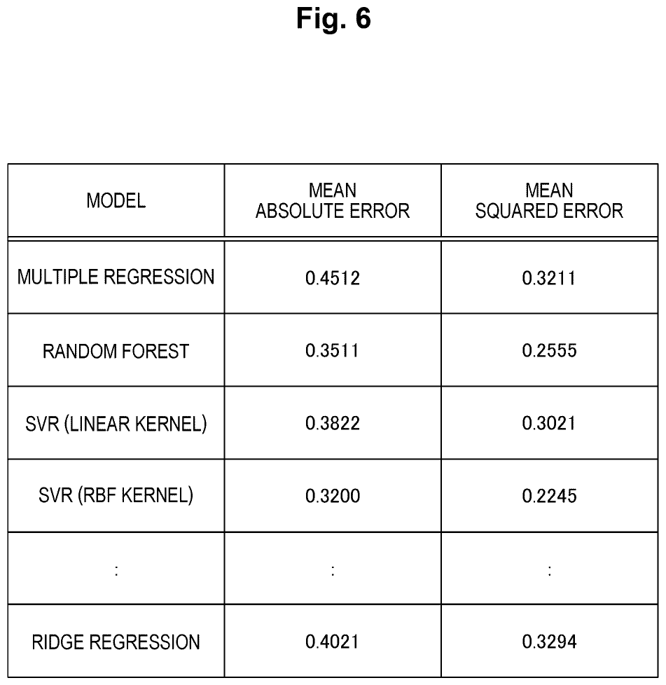

FIG. 6 is a conceptual diagram of a table forming the evaluation value storage DB. The evaluation value storage DB 23 manages mean absolute errors and mean squared errors of machine learning models for each type of the model.

### <Time Discount Rate Estimation Model DB>

The time discount rate estimation model DB 24 manages a time discount rate estimation model for machine learning, and description thereof is omitted here.

### <Unknown User's Behavior Data DB>

The unknown user's behavior data DB 25 has a data structure similar to that of the behavior data DB (see FIGS. 4(a) and 4(b)) and manages behavior data of an unknown user as input data used for estimating the time discount rate.

### <Each Functional Configuration>

Next, each functional configuration of the time discount rate estimation apparatus 1 in the learning phase will be described.

The behavior data preprocessing unit 11 generates preprocessed behavior data as behavior data indicating a behavior of a predetermined user by calculating a summary statistic amount for each attribute value and also calculating a duration of a predetermined behavior based on behavior amount data and behavior date and time data. The behavior amount data numerically indicates the behavior of the predetermined user with time, and the behavior date and time data indicates the type of the behavior of the predetermined user and date and time at which the behavior regarding the type has occurred.

The behavior statistic amount calculation unit 12 generates behavior statistic feature data by calculating an average value for each behavior amount based on the preprocessed behavior data.

Based on the behavior date and time data, the behavior date and time preprocessing unit 13 generates preprocessed behavior date and time data including a behavior relationship that indicates a relationship between a current behavior and a next behavior and indicating the latest dates and times of start of all types of behaviors with respect to the current behavior.

The behavior transition calculation unit 14 generates behavior transition feature data by calculating a transition probability between the current behavior and the next behavior based on the preprocessed behavior date and time data.

The behavior difference amount calculation unit 15 generates behavior difference amount feature data by generating difference amount data regarding behavior statistics, generating difference amount data regarding behavior transition, and combining the difference amount data regarding behavior statistics and the difference amount data regarding behavior transition for the same predetermined user. The difference amount data regarding behavior statistics is generated by performing labeling for dividing the behavior statistic feature data according to a predetermined date based on date and time information in the preprocessed behavior data, dividing the behavior statistic feature data based on the label, and calculating an absolute value of an amount of difference between behavior statistic amounts in divided pieces of the data, and the difference amount data regarding behavior transition is generated by performing labeling for dividing the behavior transition feature data according to a predetermined date based on date and time information in the preprocessed behavior date and time data, dividing the behavior transition feature data based on the label, and calculating an absolute value of an amount of difference between behavior statistic amounts in divided pieces of the data.

The behavior feature correlation calculation unit 16 calculates the Pearson correlation coefficient between the time discount rate regarding time discount rate data serving as ground-truth data and the behavior statistic feature data, the behavior transition feature data, and the behavior difference amount feature data of the same user and calculates a test statistic amount for the correlation coefficient.

The feature selection unit 17 generates various types of behavior feature data by selecting a plurality of behavior features having a correlation with the time discount rate of the ground-truth data and having no similar tendency from among behavior features regarding the behavior statistic feature data, the behavior transition feature data, and the behavior difference amount feature data and combining the plurality of behavior features for the same predetermined user.

After standardizing values of the plurality of behavior features selected by the feature selection unit 17, the model learning/selection unit 18 calculates an error between a value obtained by multiplying each standardized value by a model parameter indicating each coefficient serving as a weight and the time discount rate serving as the ground-truth data and learns the model parameter (time discount rate estimation model) so as to reduce the error by a supervised machine learning method.

The time discount rate estimation unit 19 estimates a time discount rate of a specific unknown individual user from behavior data of the specific individual user serving as input data by using the machine-learned model parameter (time discount rate estimation model) and outputs the resultant time discount rate of the individual.

Each unit will be described in detail later.

### Processing or Operation of Embodiment

Next, an overview of processing or operation of the present embodiment will be described, and then detailed processing will be described. The processing will be described separately in the learning phase and the estimation phase.

### <Overview of Processing>

### (Overview of Processing in Learning Phase)

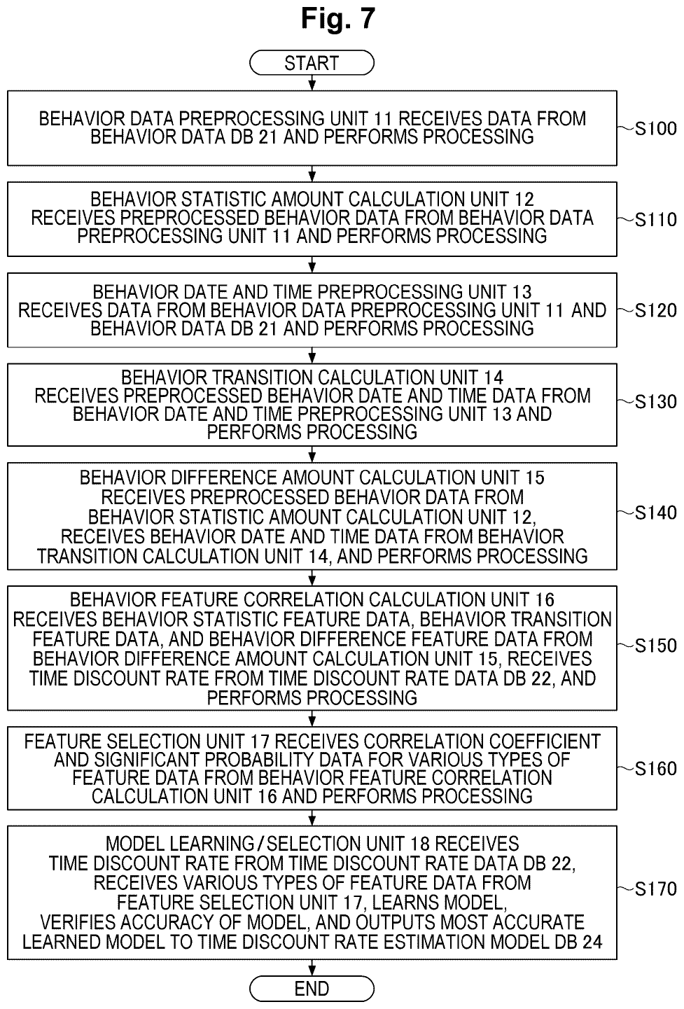

FIG. 7 is a flowchart showing an overview of time discount rate estimation processing in the learning phase.

First, the behavior data preprocessing unit 11 receives behavior data of each person from the behavior data DB 21 and performs processing (S100). The processing will be described later in detail. As shown in FIG. 4, the behavior data is roughly divided into the following two types of data: the behavior amount data (e.g. the number of steps, the heart rate, and a conversation time) in which the behavior is numerically recorded with time (see FIG. 4(a)); and the behavior date and time data in which the type of behavior and date and time at which the behavior has occurred are recorded (see FIG. 4(b)), and the behavior amount data and the behavior date and time data are recorded together with the user ID.

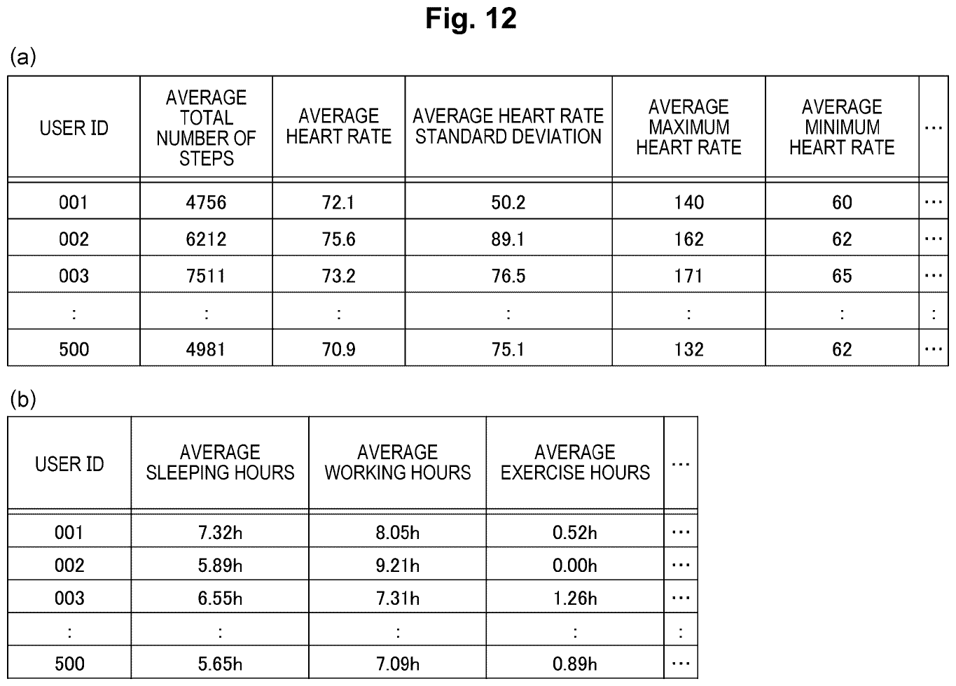

The behavior statistic amount calculation unit 12 receives the preprocessed behavior data from the behavior data preprocessing unit 11 and performs processing (S110). The processing will be described later in detail. FIG. 12 shows an example of data obtained as output data of the behavior statistic amount calculation unit 12.

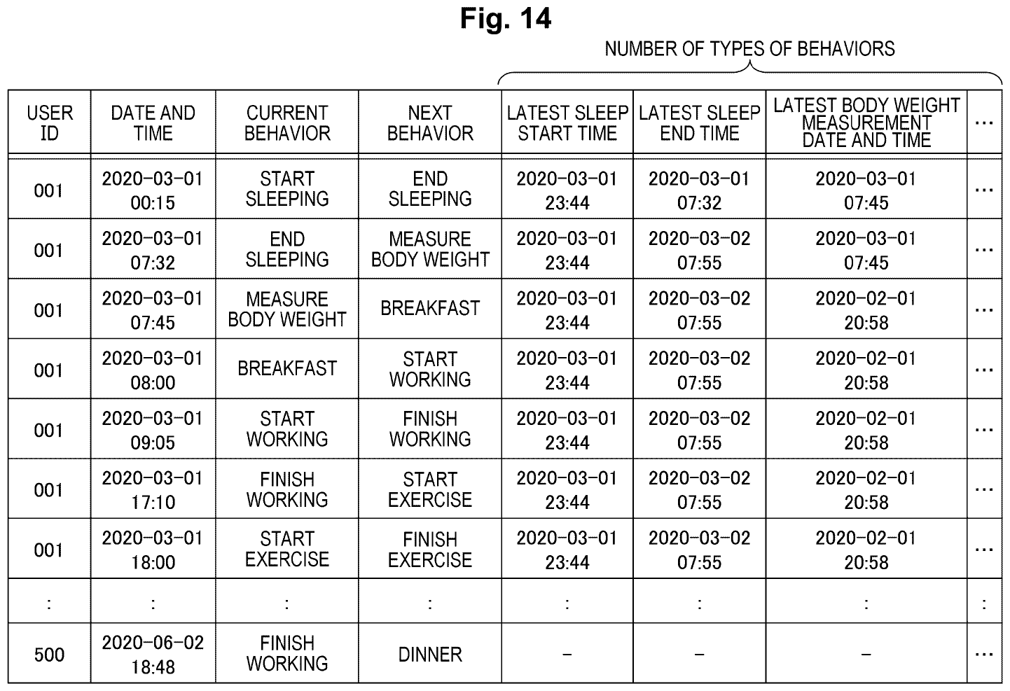

The behavior date and time preprocessing unit 13 receives the preprocessed behavior data from the behavior data preprocessing unit 11, receives data from the behavior data DB 21, and performs processing (S120). The processing will be described later in detail. FIG. 14 shows an example of data obtained as output data of the behavior date and time preprocessing unit 13.

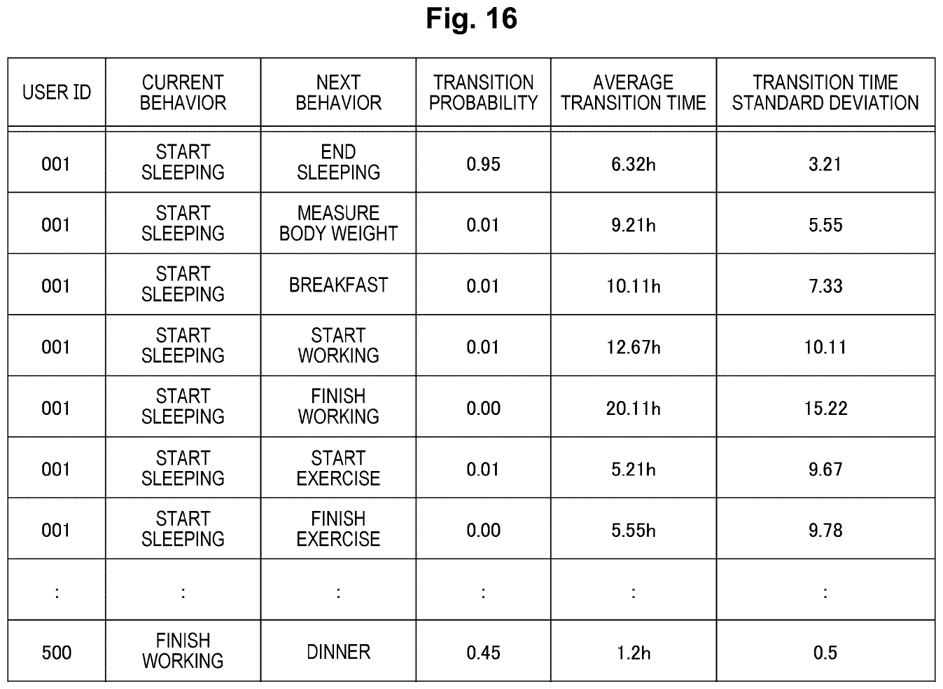

The behavior transition calculation unit 14 receives behavior date and time data from the behavior date and time preprocessing unit 13 and performs processing (S130). The processing will be described later in detail. FIG. 16 shows an example of data obtained as output data of the behavior transition calculation unit 14.

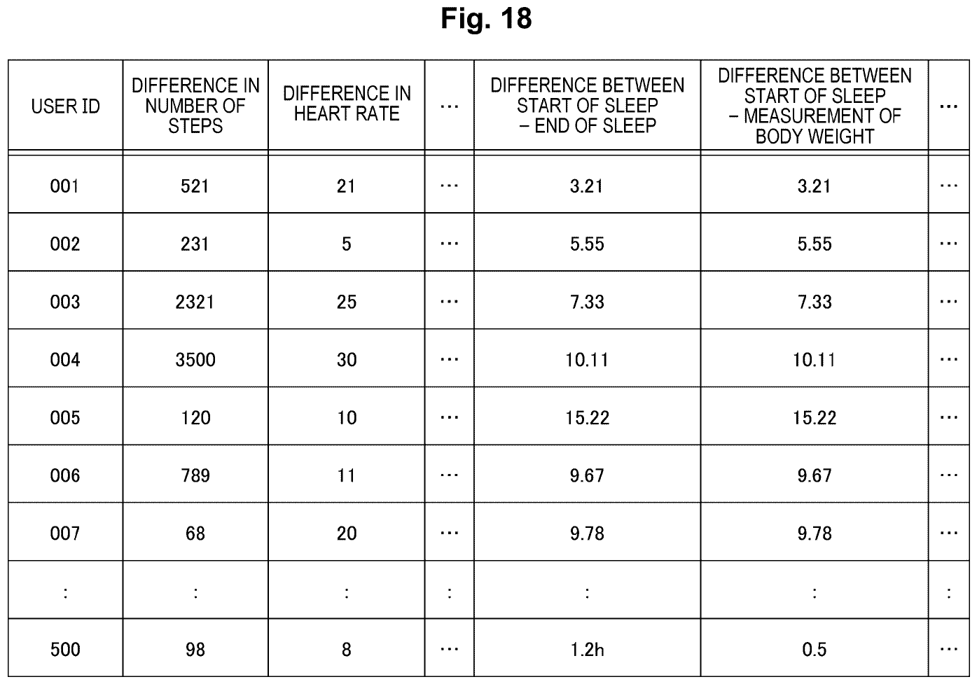

The behavior difference amount calculation unit 15 receives behavior statistic feature data from the behavior statistic amount calculation unit 12, receives behavior transition feature data from the behavior transition calculation unit 14, and performs processing (S140). The processing will be described later in detail. FIG. 18 shows an example of data obtained as output data of the behavior difference amount calculation unit 15.

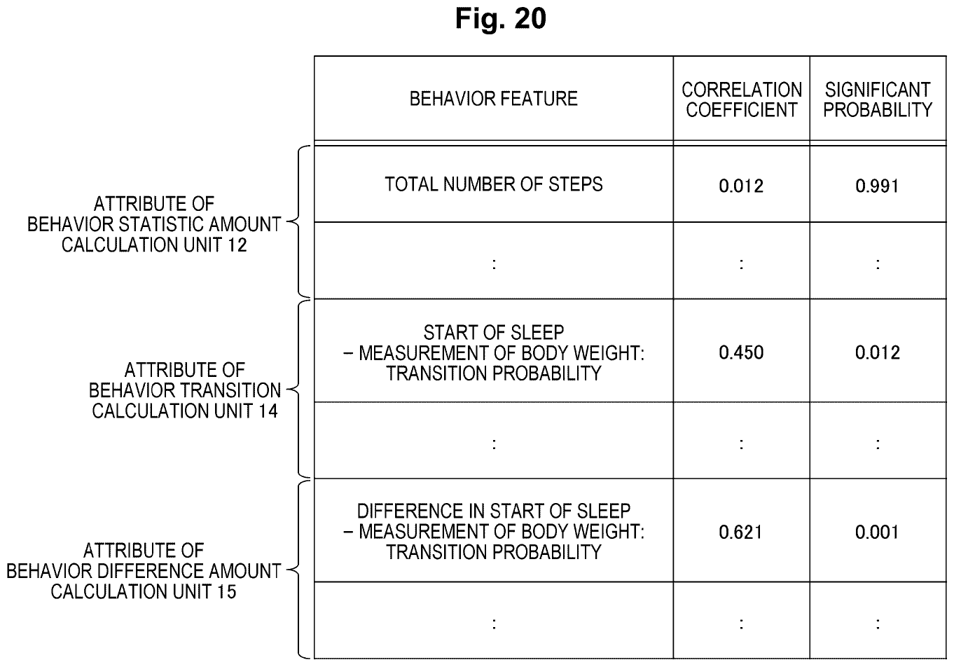

The behavior feature correlation calculation unit 16 receives the behavior statistic feature data, the behavior transition feature data, and behavior difference feature data from the behavior difference amount calculation unit 15, receives the time discount rate data as ground-truth data of machine learning from the time discount rate data DB 22, and performs processing (S150). The processing will be described later in detail. FIG. 20 shows an example of data obtained as output data of the behavior feature correlation calculation unit 16.

The feature selection unit 17 receives a correlation coefficient and significant probability data for various types of feature data from the behavior feature correlation calculation unit 16 and performs processing (S160). The processing will be described later in detail.

The model learning/selection unit 18 receives the time discount rate from the time discount rate data DB 22, receives various types of feature data from the feature selection unit 17, learns a model, verifies accuracy of the model, and outputs the most accurate learned model to the time discount rate estimation model DB 24 (S170). The processing will be described later in detail.

### (Overview of Processing in Estimation Phase)

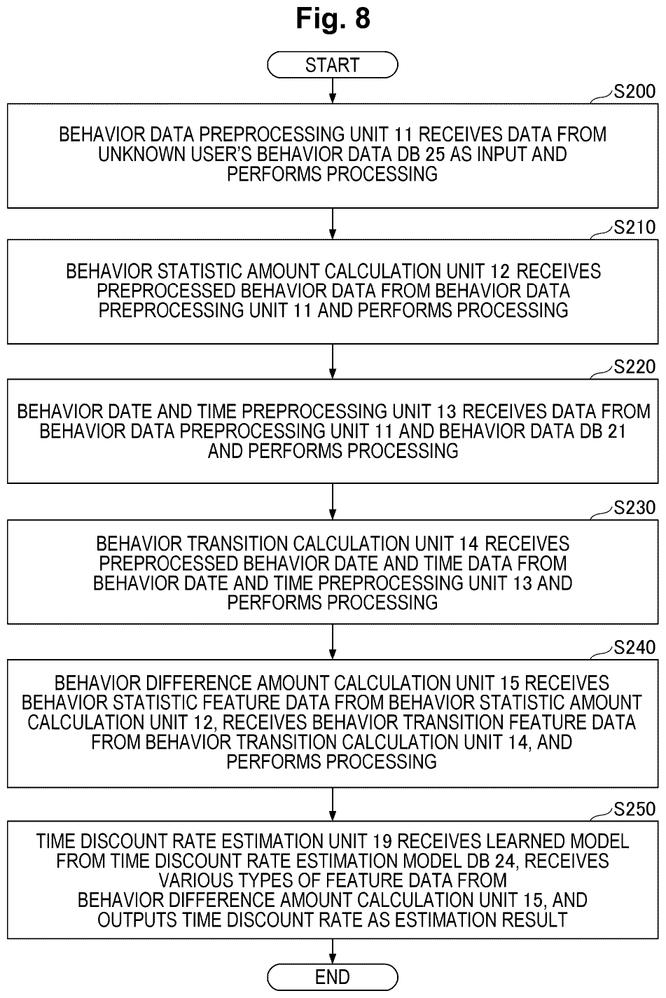

FIG. 8 is a flowchart showing an overview of the time discount rate estimation processing in the estimation phase.

First, the behavior data preprocessing unit 11 receives data from the unknown user's behavior data DB 25 as input data and performs processing (S200).

The behavior statistic amount calculation unit 12 receives the preprocessed behavior data from the behavior data preprocessing unit 11 and performs processing (S210).

The behavior date and time preprocessing unit 13 receives the preprocessed behavior data from the behavior data preprocessing unit 11, receives data from the behavior data DB 21, and performs processing (S220).

The behavior transition calculation unit 14 receives preprocessed behavior date and time data from the behavior date and time preprocessing unit 13 and performs processing (S230).

The behavior difference amount calculation unit 15 receives behavior statistic feature data from the behavior statistic amount calculation unit 12, receives behavior transition feature data from the behavior transition calculation unit 14, and performs processing (S240).

The time discount rate estimation unit 19 receives the learned model from the time discount rate estimation model DB 24, receives various types of feature data from the behavior difference amount calculation unit 15, and outputs a time discount rate as an estimation result (S250). The processing will be described later in detail.

### <Detailed Processing>

Next, detailed processing of the learning phase will be described.

### (Detailed Processing of Behavior Data Preprocessing Unit)

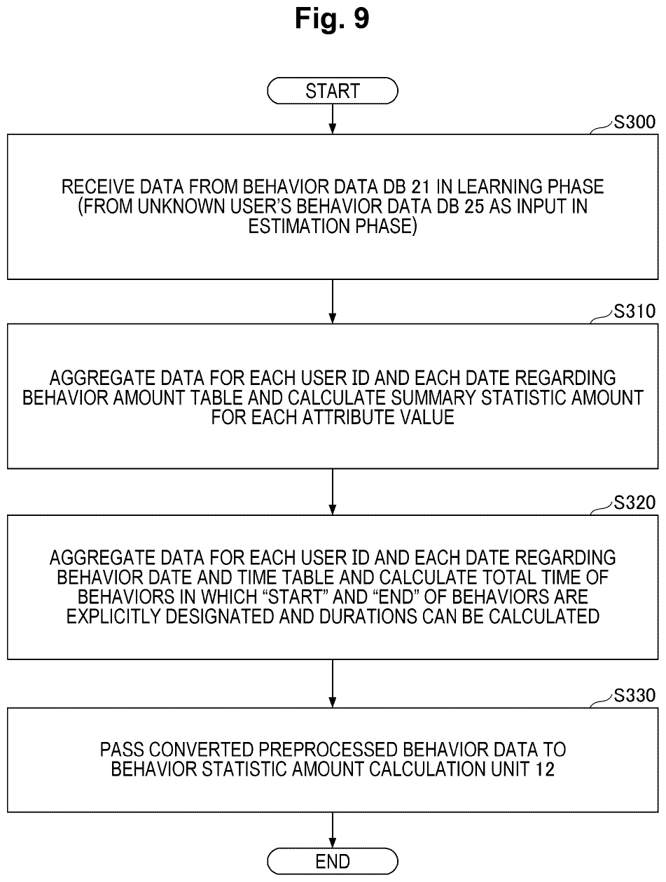

Detailed processing of the behavior data preprocessing unit 11 will be described with reference to FIG. 9. FIG. 9 is a flowchart showing the processing of the behavior data preprocessing unit.

First, the behavior data preprocessing unit 11 receives, as an example of behavior data, the behavior amount data (behavior amount management table) in FIG. 4(a) and the behavior date and time data (behavior date and time management table) in FIG. 4(b) from the behavior data DB 21 in the learning phase and from the unknown user's behavior data DB 25 as input data in the estimation phase (S300).

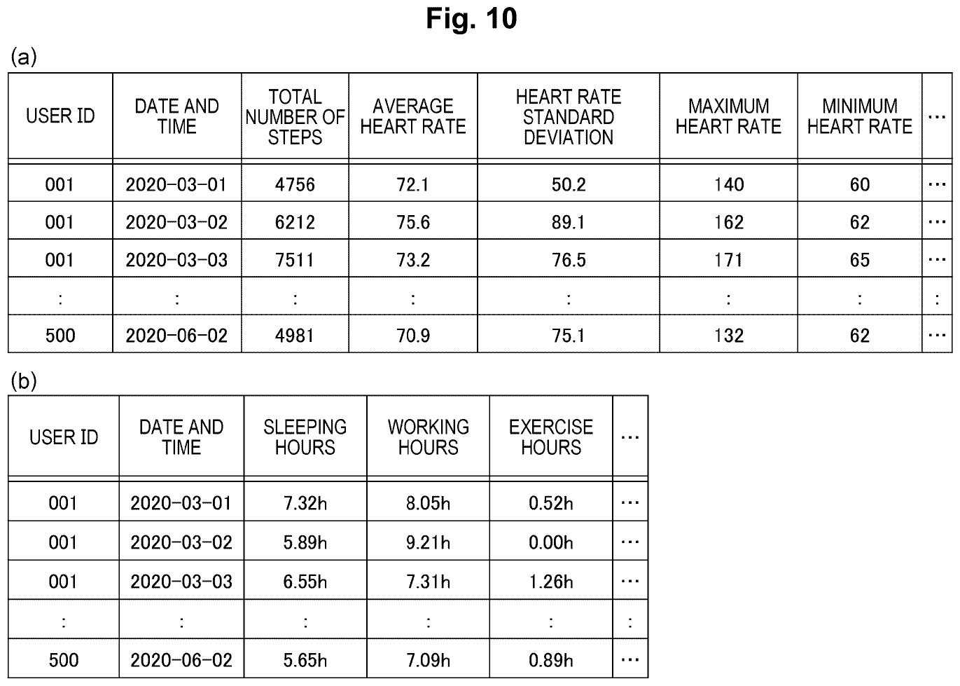

The behavior data preprocessing unit 11 aggregates data for each user ID and each date regarding the behavior amount data and calculates a summary statistic amount for each attribute value (S310). The statistic amount calculated here is a total value, average value, standard deviation, maximum value, minimum value, or the like of aggregated values of the data. The applied statistic amount can be designated by a system administrator for each attribute. FIG. 10 shows an example where the “number of steps” serving as the behavior amount and the “heart rate” are calculated by designating a “total value” for the “number of steps” and designating an average value, standard deviation, maximum value, and minimum value for the “heart rate”.

The behavior data preprocessing unit 11 aggregates data for each user ID and each date regarding the behavior date and time table and calculates a total time of behaviors in which “start” and “end” of the behaviors are explicitly designated and durations thereof can be calculated. For example, FIG. 10 shows an example where the duration is calculated from a difference between dates and times of behaviors “start sleeping” and “end sleeping”, “start working” and “finish working”, and “start exercise” and “finish exercise”. In the example, when the durations are observed a plurality of times in one day, a total time of the durations is calculated.

The behavior data preprocessing unit 11 passes the converted preprocessed behavior data (see FIGS. 10(a) and 10(b)) to the behavior statistic amount calculation unit (S330).

### (Detailed Processing of Behavior Statistic Amount Calculation Unit)

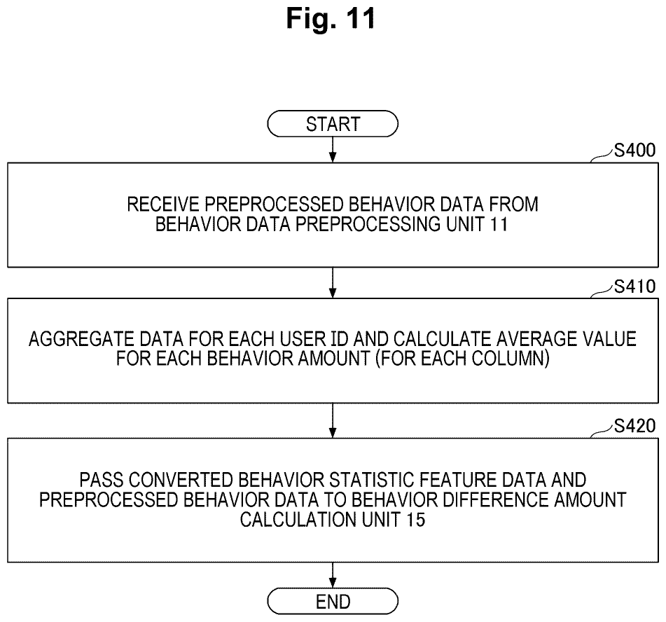

Detailed processing of the behavior statistic amount calculation unit 12 will be described with reference to FIG. 11. FIG. 11 is a flowchart showing the processing of the behavior statistic amount calculation unit.

First, the behavior statistic amount calculation unit 12 receives the preprocessed behavior data from the behavior data preprocessing unit 11 (S400).

The behavior statistic amount calculation unit 12 aggregates data for each user ID and calculates an average value for each behavior amount (i.e. for each series of data) (S410).

The behavior statistic amount calculation unit 12 passes converted behavior statistic feature data and the preprocessed behavior data (see FIG. 12) to the behavior difference amount calculation unit (S420).

### (Detailed Processing of Behavior Date and Time Preprocessing Unit)

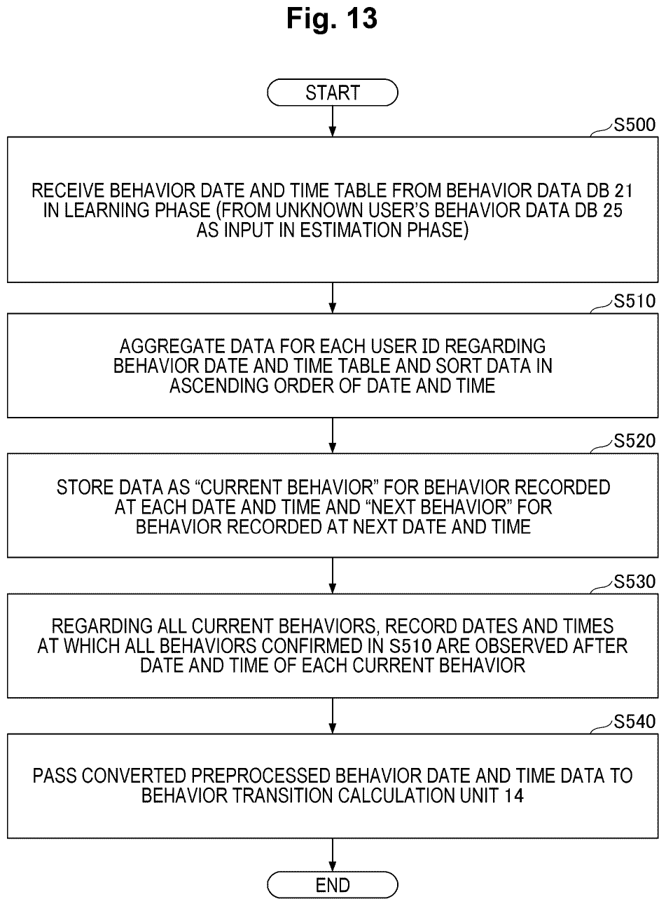

Detailed processing of the behavior date and time preprocessing unit 13 will be described with reference to FIG. 13. FIG. 13 is a flowchart showing the processing of the behavior date and time preprocessing unit.

The behavior date and time preprocessing unit 13 receives the behavior date and time data (behavior date and time management table) in FIG. 4(b) from the behavior data DB 21 in the learning phase and from the unknown user's behavior data DB 25 as input data in the estimation phase (S500). Here, the behavior amount data of FIG. 4(a) is unnecessary.

The behavior date and time preprocessing unit 13 aggregates data for each user ID regarding the behavior date and time data and sorts the data in ascending order of date and time (S510).

The behavior date and time preprocessing unit 13 stores, in the memory 102 or the like, data as “current behavior” for behavior recorded at each date and time and “next behavior” for behavior recorded at the next date and time. At this time, the behavior date and time preprocessing unit 13 stores the type of behavior recorded as the “current behavior” (S520).

Regarding all “current behaviors”, the behavior date and time preprocessing unit 13 records dates and times at which all behaviors confirmed in the processing (S510 and S520) are observed after the date and time of each current behavior (S523). The output example of FIG. 14 shows data in which dates and times of, for example, “start sleeping”, “end sleeping”, and “measure body weight” are recorded in the memory 102 or the like.

The behavior date and time preprocessing unit 13 passes converted preprocessed behavior date and time data (see FIG. 14) to the behavior transition calculation unit 14 (S540).

### (Detailed Processing of Behavior Transition Calculation Unit)

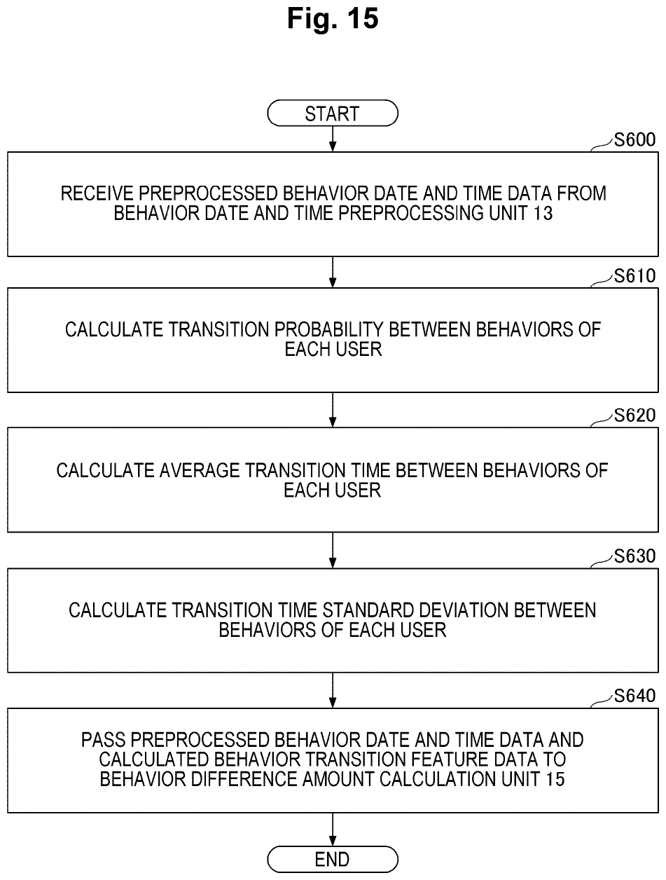

Detailed processing of the behavior transition calculation unit 14 will be described with reference to FIG. 15. FIG. 15 is a flowchart showing the processing of the behavior transition calculation unit.

First, the behavior transition calculation unit 14 receives the preprocessed behavior date and time data from the behavior date and time preprocessing unit 13 (S600).

The behavior transition calculation unit 14 calculates a transition probability between behaviors of each user (S610). Specifically, the behavior transition calculation unit 14 aggregates data for each user ID and each “current behavior”, counts the number of pieces of the data, and sets the counted number as the number of observations of the current behavior. Next, the behavior transition calculation unit 14 aggregates data for each user ID, each “current behavior”, and each “next behavior”, counts the number of pieces of the data, and sets the counted number as the number of simultaneous observations of the current behavior and the next behavior. For each type of behavior, the behavior transition calculation unit 14 stores a value obtained by dividing the number of simultaneous observations of the current behavior and the next behavior by the number of observations of the current behavior in the memory 102 as a transition probability between each current behavior and each next behavior.

The behavior transition calculation unit 14 calculates an average transition time between behaviors of each user (S620). Specifically, the behavior transition calculation unit 14 aggregates data for each user ID and each “current behavior”, calculates a difference from date and time of the next observation of each behavior, and stores an average value of the differences as an average transition time between each current behavior and each next behavior.

The behavior transition calculation unit 14 calculates a transition time standard deviation between behaviors of each user (S630). Specifically, the behavior transition calculation unit 14 aggregates data for each user ID and each “current behavior”, calculates a difference from date and time of the next observation of each behavior, and stores a standard deviation of the differences in the memory 102 as a transition time standard deviation between each current behavior and each next behavior.

The behavior transition calculation unit 14 passes the preprocessed behavior date and time data and behavior transition feature data (see FIG. 16) calculated by the behavior transition calculation unit 14 to the behavior difference amount calculation unit 15 (S640).

### (Detailed Processing of Behavior Difference Amount Calculation Unit)

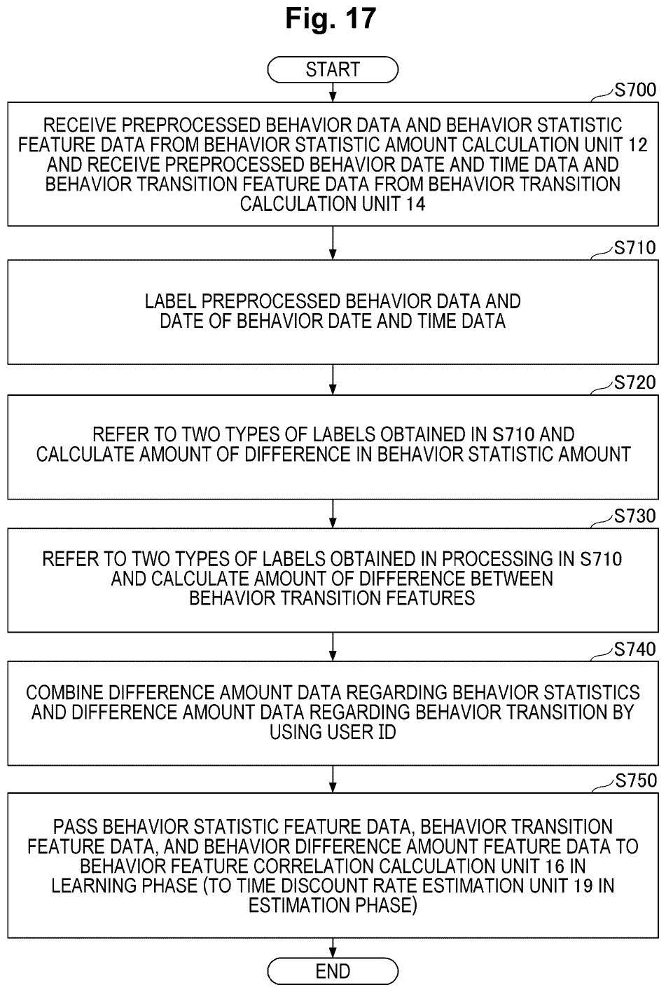

Detailed processing of the behavior difference amount calculation unit 15 will be described with reference to FIG. 17. FIG. 17 is a flowchart showing the processing of the behavior difference amount calculation unit.

First, the behavior difference amount calculation unit 15 receives the preprocessed behavior data and the behavior statistic feature data from the behavior statistic amount calculation unit 12 and receives the preprocessed behavior date and time data and the behavior transition feature data from the behavior transition calculation unit (S700).

The behavior difference amount calculation unit 15 labels the date of the preprocessed behavior data and the behavior date and time data (S710). Here, in view of human life in the real world, the system administrator selects and gives two types of label patterns. The first one is a label of “weekdays” (Monday to Friday) and “weekends” (Saturday and Sunday) obtained by referring to a calendar from date information. The second one is a label of “work” in a case where “start working” is present in the current behaviors when the data is aggregated according to a date by referring to the preprocessed behavior date and time data and a label of “work” in a case where “start working” is not present.

The behavior difference amount calculation unit 15 refers to the two types of labels obtained in the processing (S710) and calculates an amount of difference in the behavior statistic amount (S720). Specifically, the behavior difference amount calculation unit 15 extracts data to which the “weekday” label is given from the preprocessed behavior data and calls and performs the processing (S410) of the behavior statistic amount calculation unit 12. Similarly, the behavior difference amount calculation unit 15 extracts data to which the “weekend” label is given and calls and performs the processing (S410) of the behavior statistic amount calculation unit 12. The behavior difference amount calculation unit 15 combines the two output results by using the user ID, thereby obtaining an absolute value of a difference between a weekday behavior statistic amount and a weekend behavior statistic amount for the same statistic amount. Also in a case where the labels “work” and “no work” are selected, the behavior difference amount calculation unit 15 performs processing similar to the above processing with reference to the labels.

The behavior difference amount calculation unit 15 refers to the two types of labels obtained in the processing (S710) and calculates an amount of difference between behavior transition features (S730). Specifically, the behavior difference amount calculation unit 15 extracts data to which the “weekday” label is given from the preprocessed behavior date and time data and calls and performs the processing (S610, S620, and S630) of the behavior transition calculation unit 14. Similarly, the behavior difference amount calculation unit 15 extracts data to which the “weekend” label is given and calls and performs the processing (S610, S620, and S630) of the behavior transition calculation unit 14. The behavior difference amount calculation unit 15 combines the two output results by using the user ID, thereby obtaining an absolute value of a difference between the weekday behavior statistic amount and the weekend behavior statistic amount for the same statistic amount. Also in a case where the labels “work” and “no work” are selected, the behavior difference amount calculation unit 15 performs processing similar to the above processing with reference to the labels.

The behavior difference amount calculation unit 15 combines difference amount data regarding behavior statistics and difference amount data regarding behavior transition by using the user ID (S740). The resultant data serves as an output result of the behavior difference amount calculation unit 15 as behavior difference amount feature data.

The behavior difference amount calculation unit 15 passes the behavior statistic feature data, the behavior transition feature data, and the behavior difference amount feature data (see FIG. 18) to the behavior feature correlation calculation unit 16 in the learning phase and to the time discount rate estimation unit 19 in the estimation phase (S750).

### (Detailed Processing of Behavior Feature Correlation Calculation Unit)

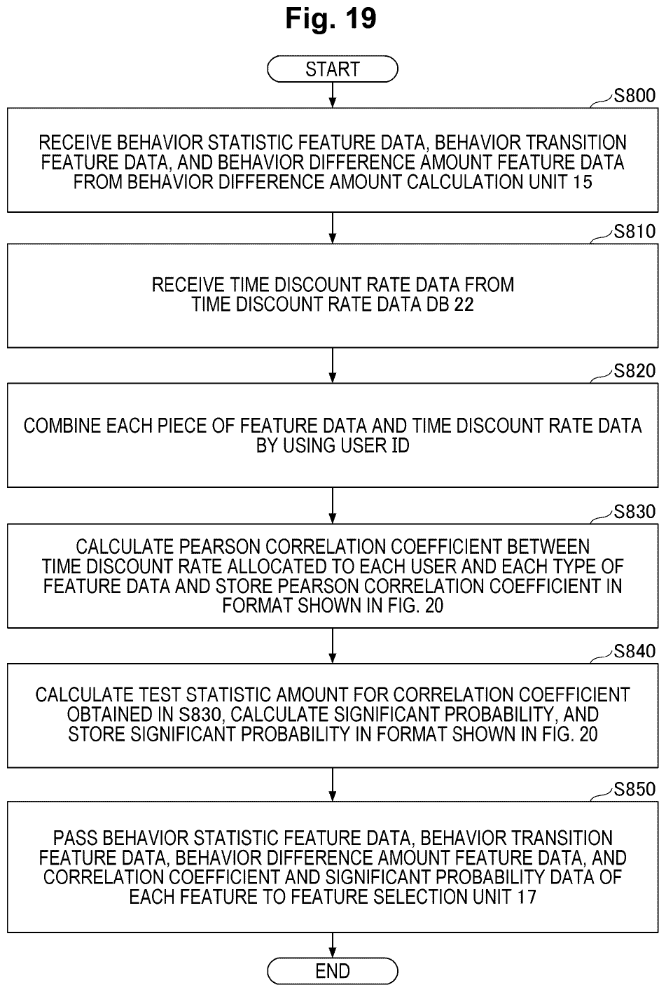

Detailed processing of the behavior feature correlation calculation unit 16 will be described with reference to FIG. 19. FIG. 19 is a flowchart showing the processing of the behavior feature correlation calculation unit.

First, the behavior feature correlation calculation unit 16 receives the behavior statistic feature data, the behavior transition feature data, and the behavior difference amount feature data from the behavior difference amount calculation unit 15 (S800).

The behavior feature correlation calculation unit 16 receives time discount rate data as ground-truth data from the time discount rate data DB 22 (S810).

The behavior feature correlation calculation unit 16 combines each type of the feature data and the time discount rate data by using the user ID (S820). A person who has answered a questionnaire or the like which is a source of the ground-truth data needs to be the same as a person who has performed behavior regarding the behavior data. Thus, here, each type of the feature data and the time discount rate data are combined by using the user ID.

The behavior feature correlation calculation unit 16 calculates a Pearson correlation coefficient between the time discount rate allocated to each user and each type of the feature data and stores the Pearson correlation coefficient in the memory 102 in a format shown in FIG. 20 (S830). The correlation indicates, for example, that the higher the time discount rate, the higher the smoking rate. In FIG. 20, for example, the correlation coefficient between the behavior feature “the total number of steps” and the time discount rate is “0.012”, and a significant probability is “0.991”. Similarly, the correlation coefficient between the behavior feature “start of sleep-measurement of body weight: transition probability” and the time discount rate is “0.450”, and the significant probability is “0.012”.

The behavior feature correlation calculation unit 16 calculates a test statistic amount for the correlation coefficient obtained in the processing (S830), calculates a significant probability, and stores the calculated significant probability in a format shown in FIG. 20 (S840).

The behavior feature correlation calculation unit 16 passes the behavior statistic feature data, the behavior transition feature data, the behavior difference amount feature data, and correlation coefficient and significant probability data (see FIG. 20) of each behavior feature to the feature selection unit 17 (S850).

### (Detailed Processing of Feature Selection Unit)

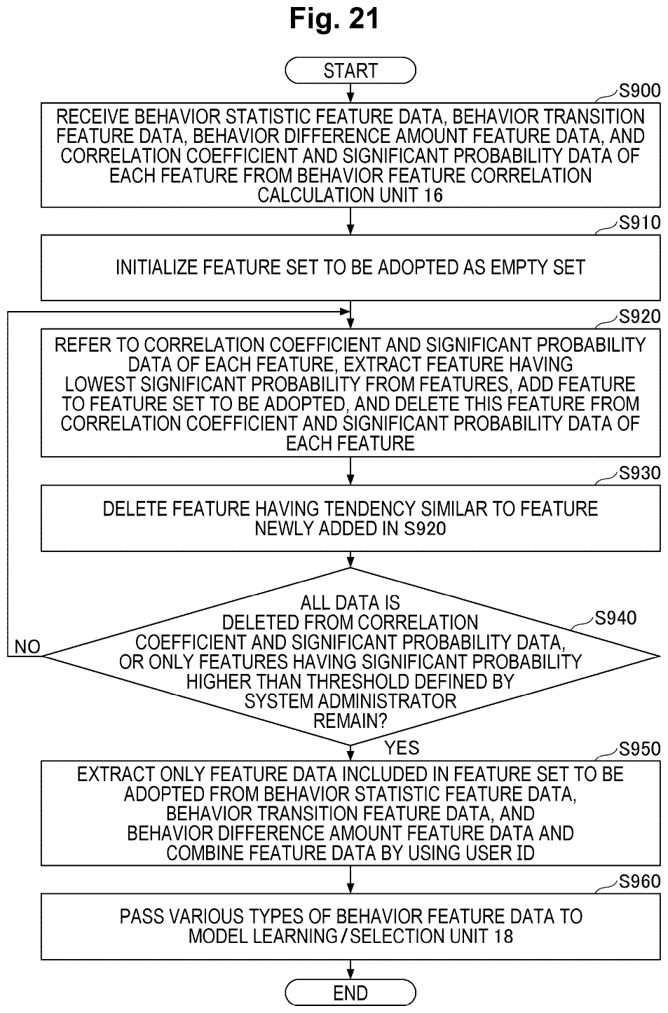

Detailed processing of the feature selection unit 17 will be described with reference to FIG. 21. FIG. 21 is a flowchart showing the processing of the feature selection unit.

First, the feature selection unit 17 receives the behavior statistic feature data, the behavior transition feature data, the behavior difference amount feature data, and the correlation coefficient and significant probability data of each feature from the behavior feature correlation calculation unit 16 (S900).

The feature selection unit 17 initializes a feature set to be adopted as an empty set (S910).

The feature selection unit 17 refers to the correlation coefficient and significant probability data of each feature, extracts a behavior feature having the lowest significant probability from the features, adds the behavior feature to the feature set to be adopted, and deletes this feature from the correlation coefficient and significant probability data of each feature (S920).

The feature selection unit 17 deletes a feature having a tendency (similar tendency) similar to the feature newly added in the processing (S920) (S930). Specifically, the feature selection unit 17 calculates an absolute value of a Pearson correlation coefficient between the feature data added in the processing (S920) and the behavior statistic feature data, the behavior transition feature data, and the behavior difference amount feature data and determines whether or not the absolute value is higher than a threshold set by the system administrator. A feature higher than the threshold, that is, a behavior feature determined to have a similar tendency to the feature added in the processing (S920) is deleted from the correlation coefficient and significant probability data (see FIG. 20) of each behavior feature. For example, in a case where the selected behavior feature is “start of sleep-measurement of body weight: transition probability”, “start of sleep-start of exercise: transition probability” is deleted as the behavior feature having a similar tendency to the behavior feature from the correlation coefficient and significant probability data of each behavior feature in FIG. 20.

In a case where all data is deleted from the correlation coefficient and significant probability data, or in a case where the feature selection unit 17 determines that only features only having a significant probability higher than the threshold defined by the system administrator remain (S940; YES), the processing proceeds to processing (S950). If not (S940; NO), the processing returns to the processing (S920).

The feature selection unit 17 extracts only feature data included in the feature set to be adopted from the behavior statistic feature data, the behavior transition feature data, and the behavior difference amount feature data and combines the feature data by using the user ID (S950). The combined data is treated as various types of behavior feature data. In this manner, the feature selection unit 17 can select a predetermined plurality of behavior features having a correlation with the time discount rate and having no similar tendency.

The feature selection unit 17 passes the various types of behavior feature data to the model learning/selection unit 18 (S960).

### (Detailed Processing of Model Learning/Selection Unit)

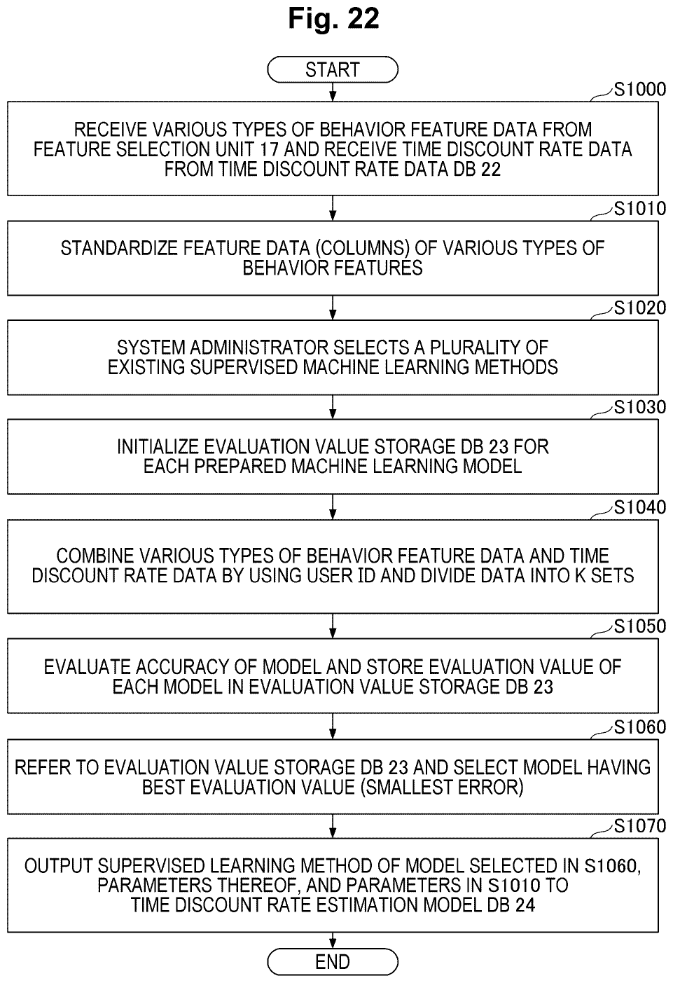

Detailed processing of the model learning/selection unit 18 will be described with reference to FIG. 22. FIG. 22 is a flowchart showing the processing of the model learning/selection unit.

First, the model learning/selection unit 18 receives the various types of behavior feature data from the feature selection unit 17 and receives the time discount rate data from the time discount rate data DB 22 (S1000).

The model learning/selection unit 18 standardizes feature data (series of data) of the various types of behavior features (S1010). Specifically, in the model learning/selection unit 18, the system administrator selects one from the following two types of methods.

Method (1): The model learning/selection unit 18 obtains an average value u and a standard deviation σ of the data and converts each value x into a z-score by (x−μ)/σ.

Method (2): The model learning/selection unit 18 obtains a maximum value max and a minimum value min of the data and converts each value x by (x−min)/(max−min).

Therefore, for example, values on different scales, such as the behavior feature “total number of steps” of 6,000 steps and the behavior feature “sleeping hours” of 6.2 hours, are treated as values on the same scale so as to follow a normal distribution having an average of 0 where the average value μ=0 and the standard deviation σ=1 are satisfied.

The model learning/selection unit 18 stores the average value and the standard deviation (or the maximum value and the minimum value) obtained from the various types of behavior feature data (series of data) at this time in the time discount rate estimation model DB 24 as model parameters used in the estimation phase. The model parameters indicate coefficients each of which serves as a weight to be multiplied by each standardized value after the plurality of behavior features selected by the feature selection unit 17 are standardized.

Next, the system administrator selects a plurality of existing supervised machine learning methods, and the model learning/selection unit 18 receives this selection (S1020). For example, the system administrator may implement the supervised machine learning methods or may use a library prepared in a programming language. Here, representative examples of the supervised machine learning methods include known techniques such as linear regression, support vector regression, and decision tree.

The model learning/selection unit 18 initializes a table (see FIG. 6) of the evaluation value storage DB for each machine learning model prepared by the system administrator. An evaluation value is obtained by using known techniques such as “mean absolute error (MAE)” and “mean squared error (MSE)” (S1030).

The model learning/selection unit 18 combines the various types of behavior feature data and the time discount rate data by using the user ID and divides the data into K sets (S1040). At this time, the system administrator selects one of the following two methods as a data division method.

Method [1]: The model learning/selection unit 18 divides the data such that each set has the same number of pieces of data. When the number of pieces of data can be sufficiently prepared (e.g. several hundreds or more), the method [1] is desirably selected.

Method [2]: The model learning/selection unit 18 divides the data such that the number of pieces of data of each set is one, that is, such that the total number of pieces of data is the same as the number of sets K. When the number of pieces of data cannot be sufficiently prepared (e.g. less than one hundred), the method [2] is desirably selected.

The model learning/selection unit 18 evaluates accuracy of (time discount rate estimation) models and stores an evaluation value of each model in the evaluation value storage DB 23 (S1050). Specifically, the model learning/selection unit 18 divides the data sets divided in the processing (S1040) such that one set serves as evaluation data and the other sets (K−1) serve as data for learning. The model learning/selection unit 18 trains each supervised machine learning model selected in the processing (S1020) by using data for learning (ground-truth data) obtained from questionnaire results or the like, inputs the evaluation data to the obtained model, and calculates an error between an output result and the ground-truth data by using an evaluation index in the processing (S1030). The model learning/selection unit 18 repeats the processing (S1050) such that all the sets serve as the evaluation data, averages the obtained evaluation indexes, and stores the averaged evaluation index together with each machine learning model in the evaluation value storage DB 23.

The model learning/selection unit 18 refers to the table in the evaluation value storage DB 23 and selects a model having the best evaluation value (smallest error) (S1060). At this time, in a case where there is a model in which minimum values are recorded for all the evaluation indexes, the model is automatically selected. In a case where minimum values for the evaluation indexes are obtained in different models, the system administrator selects a model according to the following policy.

Policy <1>: In a case where it is desired to obtain a model whose prediction result has a small outlier, the system administrator selects a model having a minimum value in the mean squared error (MSE).

Policy <2>: In cases other than the policy <1>, the system administrator selects a model having a minimum value in the mean absolute error (MAE).

The model learning/selection unit 18 outputs the supervised learning method of the model selected in the processing (S1060), parameters thereof, and parameters in the processing (S1010) to the time discount rate estimation model DB 24 (S1070).

As described above, the time discount rate estimation apparatus 1 can define a model parameter to be allocated to each behavior feature so as to minimize an error from the time discount rate serving as the ground-truth data.

### (Detailed Processing of Time Discount Rate Estimation Unit)

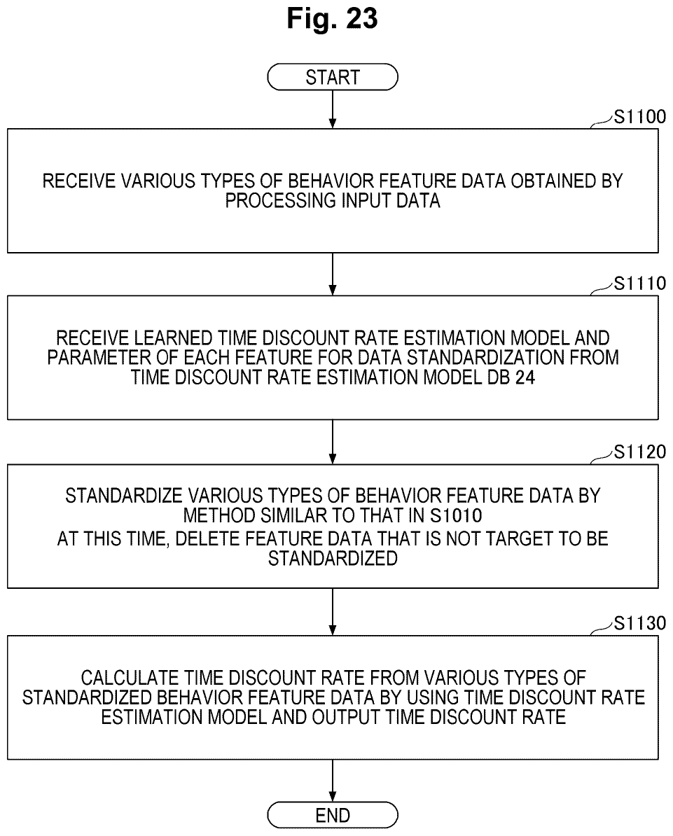

Detailed processing of the time discount rate estimation unit 19 will be described with reference to FIG. 23. FIG. 23 is a flowchart showing the processing of the time discount rate estimation unit 19.

The time discount rate estimation unit 19 receives, from the behavior difference amount calculation unit 15, various types of behavior feature data obtained by processing input data (S1100).

The time discount rate estimation unit 19 receives the learned time discount rate estimation model and the parameter of each feature for data standardization (see the processing (S1010)) from the time discount rate estimation model DB 24 (S1110).

The time discount rate estimation unit 19 standardizes the various types of behavior feature data by a method similar to that in the processing (S1010). At this time, the time discount rate estimation unit 19 deletes behavior feature data that is not a target to be standardized (S1120).

The time discount rate estimation unit 19 calculates the time discount rate from the various types of standardized behavior feature data by using the time discount rate estimation model and outputs the time discount rate (S1130).

### Main Effects of Embodiment

As described above, according to the present embodiment, the time discount rate estimation apparatus 1 can estimate the time discount rate from behavior observed by a wearable device or the like, and thus it is possible to accurately estimate the time discount rate of an individual without depending on a measurement method using questionnaires.

The behavior data preprocessing unit 11 processes conversion, aggregation, and the like of behavior data, and thus the behavior statistic amount calculation unit 12 and the behavior difference amount calculation unit 15 can easily handle the behavior data. Similarly, the behavior date and time preprocessing unit 13 processes conversion, aggregation, and the like of behavior data, and thus the behavior transition calculation unit 14 and the behavior difference amount calculation unit 15 can easily handle the behavior data.

Further, the behavior data preprocessing unit 11 statistically (with a statistic amount) processes behavior data that can be observed as a quantity, and the behavior transition calculation unit 14 extracts a transition feature between behaviors regarding behavior data that can be observed as an event date and time and uses the transition feature for model learning. This makes it possible to accurately estimate the time discount rate of the user.

The behavior difference amount calculation unit 15 outputs the behavior difference amount feature data (see FIG. 18) collected for each user, and thus the model learning/selection unit 18 can perform machine learning thereafter by a relatively easy known machine learning method such as linear regression, support vector regression, or a decision tree.

The feature selection unit 17 performs correlation analysis on the time discount rate in advance regarding feature data obtained from the behavior data, extracts a feature having a high correlation, and then deletes a feature having a tendency similar to that of the feature, thereby reducing dimensions of the feature data serving as input data and reducing data volume of the model.

The time discount rate estimation unit 19 outputs, as an analysis result, which behavior at which date and time strongly affects the time discount rate estimated from a series of behavior data, thereby providing interpretability of the estimation result.

### Supplementary Notes

The present invention is not limited to the above embodiments and may be configured or processed (operated) as described below.

Each functional configuration of the time discount rate analysis apparatus 1 can be implemented by a computer and a program as described above, but the program can also be recorded in a (non-transitory) recording medium or provided through a network such as the Internet.

### REFERENCE SIGNS LIST

1 Time discount rate analysis apparatus
11 Behavior data preprocessing unit
12 Behavior statistic amount calculation unit
13 Behavior date and time preprocessing unit
14 Behavior transition calculation unit
15 Behavior difference amount calculation unit
16 Behavior feature correlation calculation unit
17 Feature selection unit
18 Model learning/selection unit (example of model learning unit)
19 Time discount rate estimation unit
21 Behavior data DB
22 Time discount rate data DB
23 Evaluation value storage DB
24 Time discount rate estimation model DB
25 Unknown user's behavior data DB

1. A time discount rate estimation apparatus that estimates a time discount rate in a learning phase, the time discount rate estimation apparatus comprising:
a memory; and
a processor coupled to the memory and configured to:
calculate an error between a value obtained by standardizing values of a plurality of behavior features of a predetermined user and then multiplying each of the standardized values by a model parameter indicating each coefficient serving as a weight and a time discount rate serving as ground-truth data based on an answer by the predetermined user and to perform machine learning on the model parameter so as to reduce the error.

2. The time discount rate estimation apparatus according to claim 1, wherein the plurality of behavior features of the predetermined user is based on behavior data observed by a wearable device worn by the predetermined user.

3. The time discount rate estimation apparatus according to claim 2, wherein the behavior data includes behavior amount data and behavior date and time data, the behavior amount data numerically indicating a behavior of the predetermined user with time, and the behavior date and time data indicating a type of the behavior of the predetermined user and date and time at which the behavior regarding the type has occurred.

4. The time discount rate estimation apparatus according to claim 3, the processor being further configured to:
generate preprocessed behavior data by calculating a summary statistic amount for each attribute value and calculating a duration of each behavior based on the behavior amount data and the behavior date and time data;
generate behavior statistic feature data by calculating an average value for each behavior amount based on the preprocessed behavior data;
based on the behavior date and time data, generate preprocessed behavior date and time data including a behavior relationship that indicates a relationship between a current behavior and a next behavior and indicating date and time of start of another type of behavior that occurs from the current behavior to start of the next behavior of a same type of the current behavior;
generate behavior transition feature data by calculating a transition probability between the current behavior and the next behavior based on the preprocessed behavior date and time data;
generate behavior difference amount feature data by generating difference amount data regarding behavior statistics, generating difference amount data regarding behavior transition, and combining the difference amount data regarding behavior statistics and the difference amount data regarding behavior transition for a same user, the difference amount data regarding behavior statistics being generated by performing labeling for dividing the behavior statistic feature data according to a predetermined date based on date and time information in the preprocessed behavior data, dividing the behavior statistic feature data based on the label, and calculating an absolute value of an amount of difference between behavior statistic amounts in divided pieces of the data, the difference amount data regarding behavior transition being generated by performing labeling for dividing the behavior transition feature data according to a predetermined date based on date and time information in the preprocessed behavior date and time data, dividing the behavior transition feature data based on the label, and calculating an absolute value of an amount of difference between behavior statistic amounts in divided pieces of the data;
calculate a Pearson correlation coefficient between the time discount rate regarding time discount rate data serving as the ground-truth data and the behavior statistic feature data, the behavior transition feature data, and the behavior difference amount feature data of the predetermined user and calculate a test statistic amount for the correlation coefficient; and
generate various types of behavior feature data by selecting a plurality of behavior features having a correlation with the time discount rate of the ground-truth data and having no similar tendency from among behavior features of the behavior statistic feature data, the behavior transition feature data, and the behavior difference amount feature data and combining the plurality of behavior features for each user, wherein
values of the selected plurality of behavior features are standardized.

5. A time discount rate estimation apparatus that estimates a time discount rate in an estimation phase, the time discount rate estimation apparatus comprising:
a memory; and
a processor coupled to the memory and configured to:
by using a machine-learned model parameter obtained by calculating an error between a value obtained by standardizing values of a plurality of behavior features of a predetermined user and then multiplying each of the standardized values by a model parameter indicating each coefficient serving as a weight and a time discount rate serving as ground-truth data based on an answer by the predetermined user and performing machine learning on the model parameter so as to reduce the error, calculate a time discount rate based on various types of behavior feature data in which values of a plurality of behavior features of a specific user are standardized and output the time discount rate.

6. A machine learning method of performing machine learning on a model parameter for estimating a time discount rate in a learning phase, comprising:
calculating, by a computer, an error between a value obtained by standardizing values of a plurality of behavior features of a predetermined user and then multiplying each of the standardized values by a model parameter indicating each coefficient serving as a weight and a time discount rate serving as ground-truth data based on an answer by the predetermined user and performing machine learning on the model parameter so as to reduce the error.

7. A time discount rate estimation method of estimating a time discount rate in an estimation phase, comprising:
by using a machine-learned model parameter obtained by the method of claim 6, calculating, by a computer, a time discount rate based on various types of behavior feature data in which values of a plurality of behavior features of a specific user are standardized and outputting the time discount rate.

8. A non-transitory computer-readable recording medium storing a program configured for causing a computer to execute the method of claim 6.
